(19) United States
(12) Patent Application Publication
(10) Pub. No.: US 2004/0113919 A1
(43) Pub. Date: Jun. 17, 2004

(54) Digital prepress color viewing tool

(75) Inventor: Wayne Hawksworth, Heatherton Village (GB)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Imagelinx International Ltd., Kirkby-in-Ashfield (GB)

(21) Appl. No.: 10/320,326

(22) Filed: Dec. 16, 2002

(51) Int. Cl. G09G 5/02

(52) U.S. Cl. 345/592

(57) ABSTRACT

A digital prepress tool for viewing color separations is described, including suggestions for how to implement the tool within a native artwork production environment, such as Adobe Illustrator™. The invention allows for the prepress work of viewing color separations to be accomplished without conversion to a proprietary file format, and with improved efficiency.

### FIELD OF THE INVENTION

This invention generally relates to reproduction of digital artwork. More specifically, the invention relates to a software tool for prepress viewing of color separations in digital artwork within in a native artwork production environment.

### BACKGROUND OF THE INVENTION

Color artwork, which often includes a plurality graphic or text objects, may be reproduced using any of a variety of different printing processes, such as offset lithography, gravure, silk screening, or flexography. For an accurate reproduction of color variations using any of these methods, two or more different inks are applied, for example, to separate lithographic plates. At minimum, three different ink colors (and hence three different lithographic plates) are needed to approximate the spectrum of colors seen with a human eye. However, in many cases, for example, where only gray tones are needed, only two inks are used; in others, for example, where an especially bright or dark color is desired, more than three inks may be used.

Conventionally, a specific mixture of colors, called “process colors”, have been used in commercial printing processes. Process colors are mixed from four “pure” process colors, which include cyan, magenta, yellow, and black, or “CMYK”. (The “K” refers to black; “B” is not used in order to avoid confusion with blue.) Many commercial printing processes use CMYK color inks, either pure or in mixture, to reproduce in print color objects within a piece of artwork. In some cases, particularly where an especially bright or dark shade of color is desired separate “spot” colors, which requires their own specially mixed inks, are also used.

Color management has traditionally been a problem in color artwork reproduction. At present, artwork is often produced digitally within an artwork production environment such as Adobe Illustrator™. In an artwork production environment, a piece of digital artwork (for example, a PostScript format file), may include hundreds or even thousands of separate digital graphic and text objects. In producing these digital objects, artists do not often specify what mixture of CMYK ink is needed to reproduce the color or colors used in a particular digital object. Rather, a commercial printer must attempt to match or reproduce the color specified by an artist during prepress and print processing of digital artwork.

One conventional method for specifying and testing whether a color has been accurately reproduced involves “color separations”. Color separations are separate planes of color that have been applied to graphic objects within the digital artwork, in which only some (usually one) of the colors intended for use in print processing of the digital artwork are displayed. For example, when CMYK inks and two spot colors are intended to be used in print processing of a particular design, an artist might desire to view color separations for each of the six different inks to be used (the four CMYK inks and two spot color inks). Without viewing color separations, the artist or designer has no convenient or accurate way of previewing what will be printed on each color separation.

Recently, computer software has been used to apply color mixtures to objects within a piece of digital artwork, and to view color separations in preparation for printing with multiple inks. Commercial prepress software packages, such as Esko-Graphics Barco™ or Artwork Systems Artpro™ are currently available for viewing color separations. However, the use of such commercial software packages for prepress processing, including the application of color to objects within a finished design, has distinct disadvantages.

Some disadvantages to the use of such commercial software packages for prepress processing include the need for file format conversions. The file format of artwork submitted for prepress work is usually different from the file format used by prepress software packages. Artwork is usually produced within an artwork production environment, such as Adobe Illustrator™ or Macromedia Freehand™, and must be converted from the file format used in the artwork production environment into the file format for the prepress software package before prepress processing can be completed. File conversion errors often result.

Other disadvantages to file conversion include the inability of artists to make changes to artwork that has already been submitted for prepress processing. Artwork usually goes through a long approval process before being submitted for prepress processing since changes after submission may be costly or impossible to make. In some conventional prepress software packages, a piece of digital artwork is submitted for batch processing by a server connected through a network to the artwork production environment. Color separations are produced for the digital artwork (submitted in batches) using an engine on the server before being transferred back to the artwork production environment. File conversions are often necessary (resulting in the disadvantages discussed above). Additional hardware or software may be needed, for example, to expand the bandwidth of the network for easier transfer of large graphics files to and from the server. Disadvantageously, a minor change to a small aspect of artwork submitted for prepress processing may nonetheless require prepress processing to be repeated when artwork is processed in batches by a server. Hence, if a company wishes to make a slight alteration to an object of text within a piece of digital artwork that has already had prepress processing completed, the prepress processing work might have to be entirely redone.

Disadvantageously, the use of proprietary file formats and software packages requires additional training. Hence, additional company resources (beyond those necessary for simply creating artwork) are required for artwork to be prepared for printing. A smaller company might be unable to afford printing of high quality artwork for advertisements or product packaging simply because prepress processing is unaffordable.

Other disadvantages include inefficiencies that currently exist within prepress software packages for viewing color separations in digital artwork. Color separations are currently created manually within many commercially available software packages for prepress work. A single piece of digital artwork may not require much time, but when thousands of such objects are included with a single piece of artwork, a large amount of resources might be saved by removing steps from the sequence or by otherwise improving the efficiency of color separation analysis.

Attempts have been made to view color separations within a native artwork production environment. However, color separation viewing in native artwork production environments conventionally requires a large number of steps, for example, in reassigning colors to a plurality of objects within a piece of artwork. Such conventional methods are impractical when many different color separations for many pieces of digital artwork must be viewed. There is a need for a faster, and more accurate tool for viewing color separations of digital artwork in a native artwork production environment.

There is, therefore, a need for an efficient prepress tool for viewing accurate, high quality color separations for digital artwork in a native artwork production environment.

### BRIEF SUMMARY OF THE INVENTION

The present invention meets the foregoing need by providing digital prepress color viewing tools designed to function within a native artwork production environment, such as Adobe Illustrator™. The color viewing tools include a color viewing palette, replacing a plurality of existing tools with a single, integrated tool for viewing color separations. By allowing a user to quickly view each color separation within a design before print processing, the present invention allows the user to easily visualize color separations, illegal colors, and color trap details.

In accordance with the method and system of the present invention, color separations are viewed within the same software package or application in which finished artwork has been created (i.e., within the “native” artwork production environment). A color separation for each process or spot color, showing every graphic or text object included in the digital artwork (which uses the particular process or spot color associated with a particular color separation), may be viewed on screen without any file conversion. The invention also allows for an artist or prepress operator using the invention to see color separations that have been applied within the digital artwork immediately, whereas previous prepress software packages have either: required information to be transmitted to and received from a server before color separations are displayed, or forced a user to view color separations outside the native artwork production environment. The present invention provides an unprecedented level of integration between artwork production and prepress processing.

Using the method and system of the present invention, it is possible for an artist to view color separations immediately within the native artwork production environment, and the present invention removes a need for separate prepress processing of artwork before print processing. In effect, the present invention allows for easier revisions or updates to previously finished artwork because fewer digital file conversions are needed in order to produce color separations for previewing. In accordance with an embodiment of the present invention, text in a piece of digital artwork is not converted to paths, files are not saved in a non-native format or converted to a proprietary software system, and there is no need for files to be reconverted after prepress processing before being viewed.

In an embodiment of the present invention, after the method of the present invention has been carried out, digital artwork is submitted for print processing, for example, as a PostScript format file. The digital artwork submitted is usually received by a Raster Image Processor (RIP) for screen ruling, dot gain analysis, and angle, dot shape or structure assignment. The digital artwork might then be sent to an output device, such as a plate or film setter. For gravure printing, the bitmap data is either sent to a digital engraving machine or data is output to film, and engraved on a cylinder. After using the digital prepress color viewing tool of the present invention, no additional prepress color separation viewing is needed.

In one embodiment, the invention has been implemented as a plug-in for use with Adobe Illustrator™. However, as will be understood by those of ordinary skill in the art, the method and system of the present invention are susceptible to implementation in a plurality of different artwork production environments, including environments in which the prepress tools are implemented without reference to previously developed Application Programming Interface (API) or other libraries of software tools. The invention should be understood to include such alternative embodiments since the color separation viewing tools described herein might be implemented by one of ordinary skill in the art in any such alternative embodiments. In general, the method and system of the present invention may be used with any digital vector graphics applications.

In many conventional artwork production software packages, digital artwork is output as a PostScript language file. Hence, much of the terminology used to describe how colors separations are viewed in the present invention is common to the PostScript programming language. An excellent reference, including a detailed description of some of the PostScript language terms (e.g., paths, subpaths, and Bezier curves) used in the present application is publicly available at the URL: http://partners.adobe.com/asn/developer/technotes/postscript.html in the third edition of the PostScript Language Reference manual. The digital prepress color separation viewing tools of the present invention are implemented, in an embodiment, as a plug-in for Adobe Illustrator™, a commercial artwork production software package that has conventionally produced PostScript format output files. However, as described above, other programming languages or scripts might also be used to implement the digital prepress tools of the present invention in other software environments, such as Macromedia Freehand™, Adobe Acrobat™, Adobe InDesign™, or Corel Draw™.

The digital prepress tools of the present invention allow a user to view color separations of vector art objects, text items, and images colorized using opacity masks within a design. The following terms are used in accordance with the present invention: “swatch color” refers to a user defined color, which would conventionally appear in the “Swatches” palette in Adobe Illustrator™; “process color” refers to a combination of cyan, magenta, yellow and black (or “CMYK”); “process global color” refers to a process color that is formally defined within the native artwork production environment (for example, in the “Swatches” palette in Adobe Illustrator™); “spot color” refers to a specially premixed color used with its own printing device (for example, with a separate lithographic plate); “dirty color” refers to a color that cannot be mixed from a combination of pure process global colors (see below) or provided by a spot color; and “pure process global color” is a process global color that is defined to be 100% of a single process color. The pure process global colors include “process cyan”, “process magenta”, “process yellow”, and “process black”, which are conventionally defined as shown in Table 1.

TABLE 1

| PURE PROCESS | | | | |
|---|---|---|---|---|
| GLOBAL COLOR | MIXTURE | | | |
| Pure Process Cyan | 100% | 0% | 0% Yellow | 0% Black |
| | Cyan | Magenta | | |
| Pure Process Magenta | 0% | 100% | 0% Yellow | 0% Black |
| | Cyan | Magenta | | |
| Pure Process Yellow | 0% | 0% | 100% Yellow | 0% Black |
| | Cyan | Magenta | | |
| Pure Process Black | 0% | 0% | 0% Yellow | 100% Black |
| | Cyan | Magenta | | |

The invention provides a computer graphics software plug-in tool for Adobe Illustrator™, which allows operators to view specific color separations on a page. In an embodiment, a user of the present invention may turn on or off (in order to view separately or in combination) a plurality of color separations. In another embodiment, the present invention allows operators to view a specific color separation in black and white. In still another embodiment, the color separations viewed in black and white may be viewed in negative (i.e., with black and white reversed to show the color separation as it would appear as a film negative). The present invention thus may allow a prepress operator to quickly identify and remove unwanted colors from select digital objects among hundreds of different digital objects in a piece of digital artwork.

According to an embodiment of the present invention color separations are viewed by deactivating of valid pure process global colors and spot colors. Deactivating is accomplished by temporarily turning valid colors (listed, for example, in the “Swatches” palette in Adobe Illustrator™) into white colors. The present invention is also designed to accommodate text or graphic objects with specific overprint settings for use in print processing. In an embodiment, if overprint settings are turned on, white colors are set to appear transparent to a user of the present invention.

The digital prepress color separation viewing tool of the present invention is designed to be used either as a stand-alone tool or with other tools (such as color trapping or mixing tools). When used with other digital prepress tools, the present invention provides the other tools with updated color information whenever changes are made to colors within the digital artwork (for example, whenever a change is made to a color in the “Swatches” palette in Adobe Illustrator™). In an embodiment in which the invention is implemented within Adobe Illustrator™, updates are provided to other tools using standard notification routines.

In some embodiments of the present invention, users, such as graphic artists or prepress operators, work in multiple pieces of digital artwork (for example, in multiple Adobe Illustrator™ documents) simultaneously. The method and system of the present invention track current color separation settings for each piece of digital artwork in which the user is working. In an embodiment, as the user switches to a particular piece of digital artwork, color separation settings for the particular piece of digital artwork are restored. In another embodiment, by storing a piece of digital artwork in a particular way, applications in an artwork production environment are notified, and color separation are restored when the piece of digital artwork is reloaded or saved into or out of the artwork production environment.

In an embodiment of the present invention in which the native artwork production environment is Adobe Illustrator™, the present invention provides a palette plug-in tool, which replaces and extends the functionality provided by existing “Appearance”, “Swatch”, and “Color” palettes. Existing palettes or toolboxes within Adobe Illustrator™ are generally difficult or cumbersome to use. The color separation viewing tool of the present invention allows for color separations to be viewed in a more accurate, well-defined way. Advantageously, the present invention checks to see if a color is valid before allowing the color to be displayed as a color separation, only valid, printable colors are displayed. Using the method and system of the present invention, colors and color combinations are displayed or managed so that a user (for example, an artist or prepress operator) is better able to prepare digital artwork for color separation and printing processes, without a need for prepress processing in a non-native environment.

### BRIEF DESCRIPTION OF THE DRAWINGS

The foregoing and other objects, advantages, and features of the present invention will be apparent from the following detailed description and the accompanying drawings, in which:

FIG. 1A shows a screenshot of a color viewing tool in a color viewing mode, in accordance with an embodiment of the present invention;

FIG. 1B shows a screenshot of a color viewing tool in a black and white viewing mode, in accordance with an embodiment of the present invention;

FIG. 2 shows a flowchart of an overall method for viewing color separations, in accordance with an embodiment of the present invention;

FIG. 3 shows a flowchart of a method for building a color list, in accordance with an embodiment of the present invention;

FIG. 4 shows a flowchart of a method for changing a mode, in accordance with an embodiment of the present invention;

FIG. 5 shows a flowchart of a method for changing a view, in accordance with an embodiment of the present invention; and

FIG. 6 shows a flowchart of a method for changing a color, in accordance with an embodiment of the present invention.

### DETAILED DESCRIPTION OF THE INVENTION

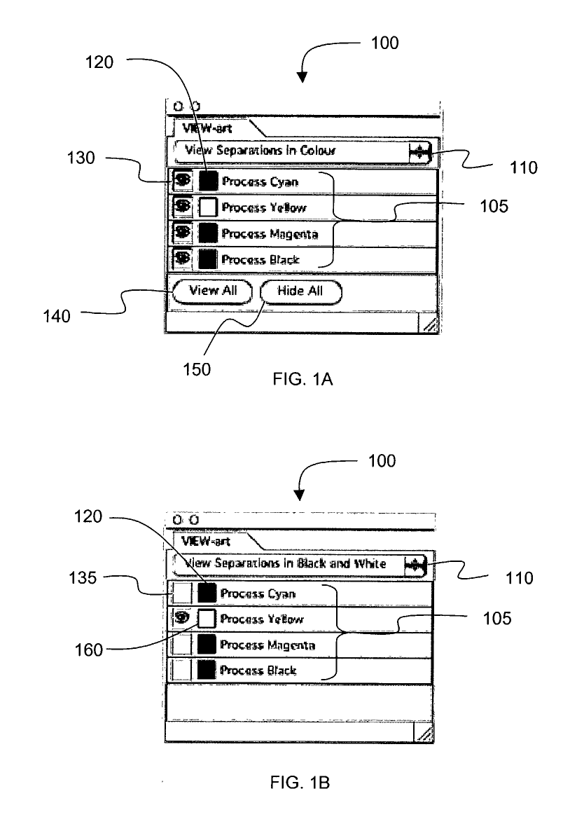

As described above, the digital prepress color viewing tool may optionally be implemented as a plug-in for Adobe Illustrator™. FIGS. 1A-B show screenshots of a color viewing tool 100 in color and black white viewing modes, in accordance with an embodiment of the invention implemented within Adobe Illustrator™. In the embodiment shown in FIGS. 1A and 1B, the color viewing tool is implemented as a floating palette.

FIG. 1A shows a digital prepress tool 100 for viewing color separations in Adobe Illustrator™, as used in accordance with an embodiment of the present invention. In FIG. 1A, the digital prepress color viewing tool 100 is in a color mode (further described below). As shown in FIG. 1A, the tool 100 includes a pull-down menu 110 for selecting a mode. In an embodiment, both black and white mode and color mode are available, and the tool is shown in black and white mode in FIG. 1B. Also shown in FIG. 1A is an example of a list of colors 105, including process cyan 120, process magenta, process yellow, and process black. The eye 130 indicates that a particular color (in this case, process cyan 120) is activated (or turned on). Clicking on the eye 130 with a mouse deactivates (or turns off) the color to which it corresponds. In the example of FIG. 1A, all colors are activated.

Two significant advantages of the present invention are the “View All” 140 and “Hide All” 150 buttons shown at the bottom of the color viewing tool 100 (in color viewing mode) in FIG. 1A. In an embodiment of the present invention, the View All button 140 is used to activate all colors in the list of colors at once. Thus, if only a single color is activated in the color viewing tool 100 (showing the color separation for that single color), a user may reactivate all colors in the list of colors 105 to see a preview of the finished print design with a single action. In a similar way, if a user is previewing a finished print design, all activated colors may be deactivated with a single action by clicking the Hide All button 150, so that a color separation may be viewed thereafter by clicking on the single color for the desired color separation, rather than by deactivating other activated colors by hand. The View All 140 and Hide All 150 buttons present a significant improvement in efficiency over conventional methods and systems for viewing color separations in a native artwork production environment, and remove the necessity of converting digital artwork into a different digital format in order to produce and view color separations.

FIG. 1B shows the digital prepress color viewing tool 100 in a black and white viewing mode, in accordance with an embodiment of the present invention. As shown in FIG. 1B, the pull-down menu 110 reflects a user change to black and white mode. In addition, in FIG. 1B all colors in the list of colors 105 have been deactivated except for process yellow 160. In an embodiment, in black and white viewing mode, only a single color (in this case, process yellow 160) may be selected if a user clicks a deactivated color (such as the deactivated 135 process cyan), then the deactivated color becomes activated and all other colors are deactivated. In addition, in black and white mode, activated single colors are shown as a tint of black (as suggested by the name of the mode).

In an embodiment, black and white viewing mode does not include the View All 140 and Hide All 150 buttons shown in FIG. 1A. Typically, a user of the digital prepress color viewing tool 100 would not desire to view more than a single color as a black and white separation at one time. In another embodiment of the digital prepress color viewing tool 100, a “View Negative” button might be used to view the negative image of a black and white color separation (i.e., an image in which black has everywhere been exchanged for white).

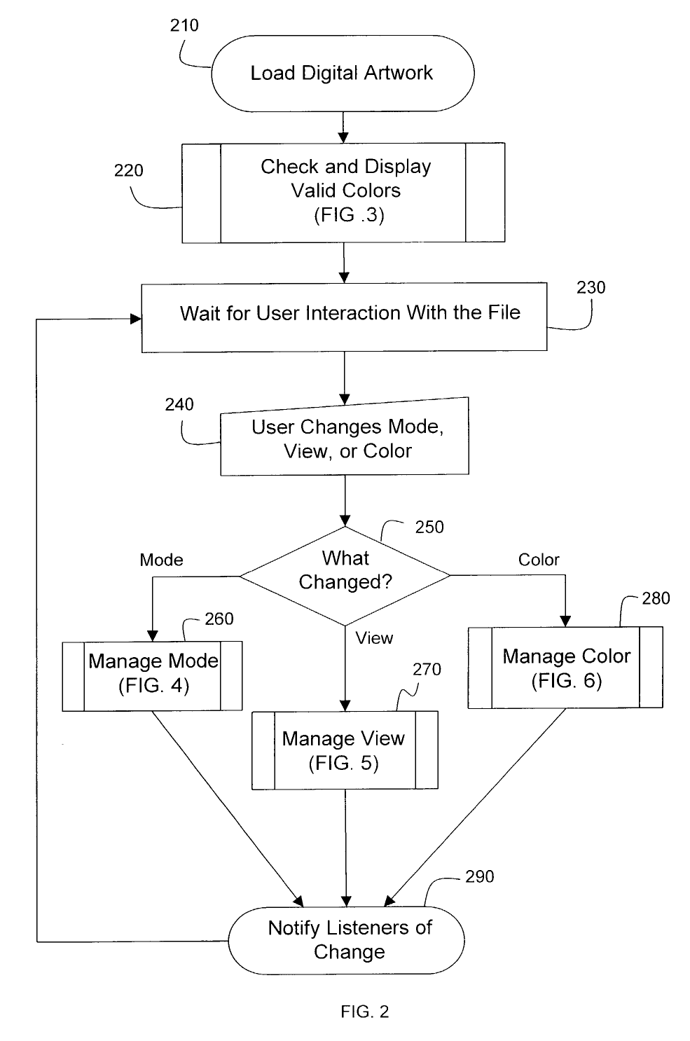

The digital prepress color viewing tool 100 operates according to an overall method shown, in an embodiment, in FIG. 2. The overall method includes an initialization phase with an extract and display valid colors sub-process 220, and a waiting phase, beginning in step 230, in which the tool 100 waits for user actions before performing steps associated with the particular user action carried out. In an embodiment, user actions include changes of a view (for example, by switching to a different Adobe Illustrator™ document window), changes of a mode (from black and white mode to color mode or from color mode to black and white mode), or changes of one or more colors in the list of colors 105. In an embodiment, a user might interact with the digital prepress color viewing tool 100 by manual input using a mouse or a keyboard.

Referring to FIG. 2, there is shown how digital artwork is loaded in a first step 210 of the overall method. In an embodiment of the present invention in which the digital prepress color viewing tool 100 has been implemented as a palette-style plug-in tool for Adobe Illustrator™, only valid Adobe Illustrator™ files (or documents) might be loaded in step 210.

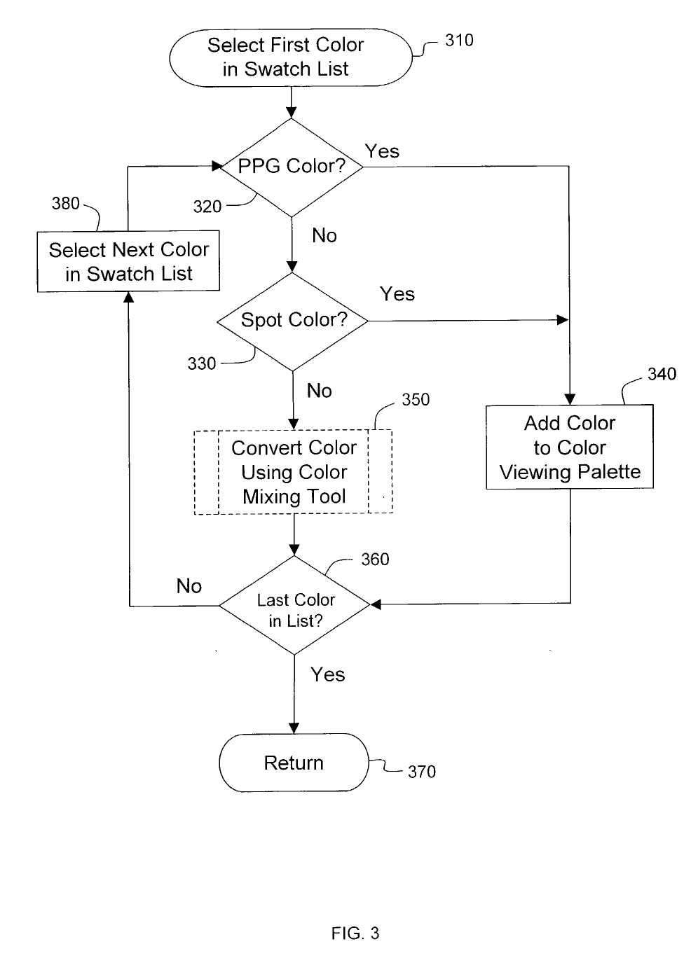

After loading of digital artwork in step 219, a list of colors (for example, the list of colors 105) is checked for whether or not the colors in the list of colors are valid (i.e., supported) before the colors are displayed. The check and display sub-process of step 220 is shown, in an embodiment in FIG. 3. As shown in FIG. 3, starting with a first color in a list of colors (for example, the process cyan 120 color in the list of colors 105), in step 310 a color is selected for processing. In steps 320 and 330, the selected color is checked for equivalence with a pure process global (“PPG”) color (as defined above) or a spot color. If the selected color is a PPG color or spot color, then in step 340 the selected color is added to the list of colors displayed in the digital prepress color viewing tool 100. If the color is not a PPG color or a spot color, then the color may optionally be converted using a prepress color mixing tool in step 350. Otherwise, it is determined in step 360 whether the selected color is the last in the list of colors. If the selected color is not the last color in the list of colors, then the method of FIG. 3 (in step 380) selects the next color in the list of colors and the method repeats from step 320, until the last color in the list of colors is processed, at which point (in step 370) the method returns to the steps of the overall method of FIG. 2.

In another embodiment of the present invention, if colors are found not to be supported in the sub-process of step 220, then a digital prepress color mixing tool might be used (for example, in step 350 of FIG. 3) in order to convert unsupported colors (such as nonstandard CMYK colors or dirty colors) into supported colors for use in connection with the digital prepress color viewing tool 100. A digital prepress color mixing tool suitable for this purpose is described in the separate co-pending patent application No. ______, the contents of which are incorporated by reference herein.

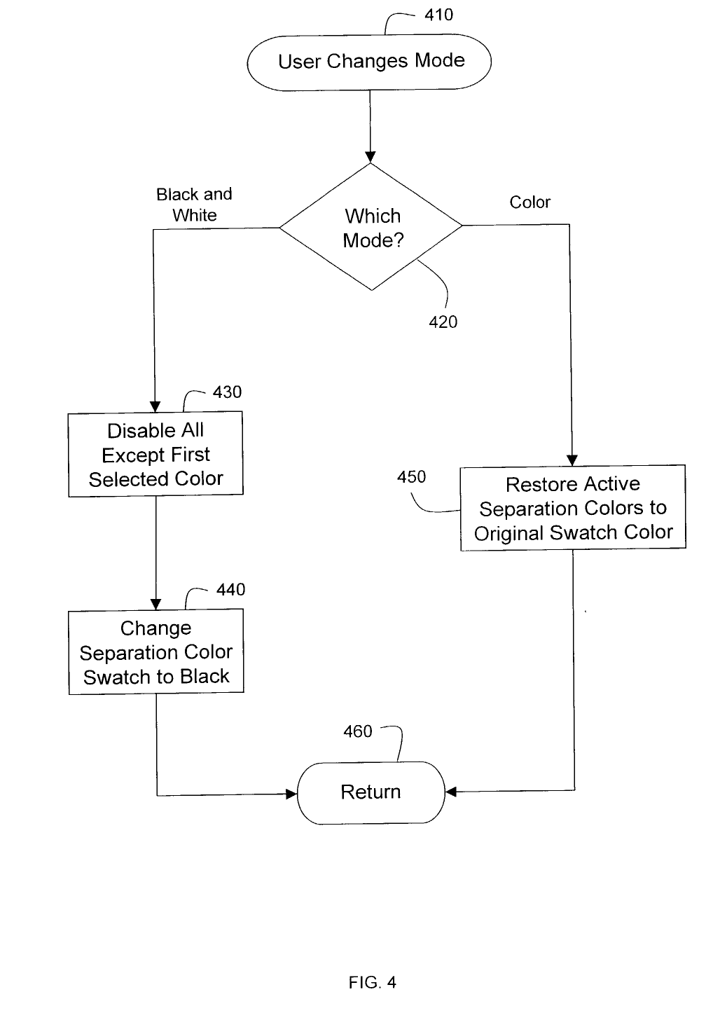

Returning to FIG. 2, the overall method continues, in an embodiment, with a step 230 of waiting for user interaction with the digital prepress color viewing tool 100, or with the piece or pieces of digital artwork with which the digital prepress color viewing tool 100 is used. In step 240, a user changes a setting in the digital prepress color viewing tool. In an embodiment, the settings that may be changed include mode, view, or color settings, and in step 250, it is determined which of these changes has occurred. FIGS. 4, 5, and 6 show embodiments of the sub-processes 260, 270, and 280 for changing mode, view, and color settings of the digital prepress color viewing tool 100, in accordance with the method and system of the present invention.

When a user changes the mode of the digital prepress color viewing tool 100, as indicated in step 410 of FIG. 4, the invention first determines (in step 420) what mode has been selected (for example, using the pull-down menu 110 shown in FIGS. 1A and 1B). If black and white mode is selected, then in step 430 all activated colors are deactivated (or disabled), for example, by setting all colors to be a white or transparent color except for the first activated color in the list of colors. In step 440, the activated color separation color swatch (for example, in the “Swatches” palette in Adobe Illustrator™) is changed to black, and the method end in step 460 by returning to the overall method shown in FIG. 2.

Alternatively, if the user has changed the digital prepress color viewing tool 100 into color viewing mode, then, in step 450, all previously activated colors (colors that were in an activated state before the digital prepress tool 100 was put into black and white mode) are reactivated, and in step 460 the method continues by returning to the overall method of FIG. 2.

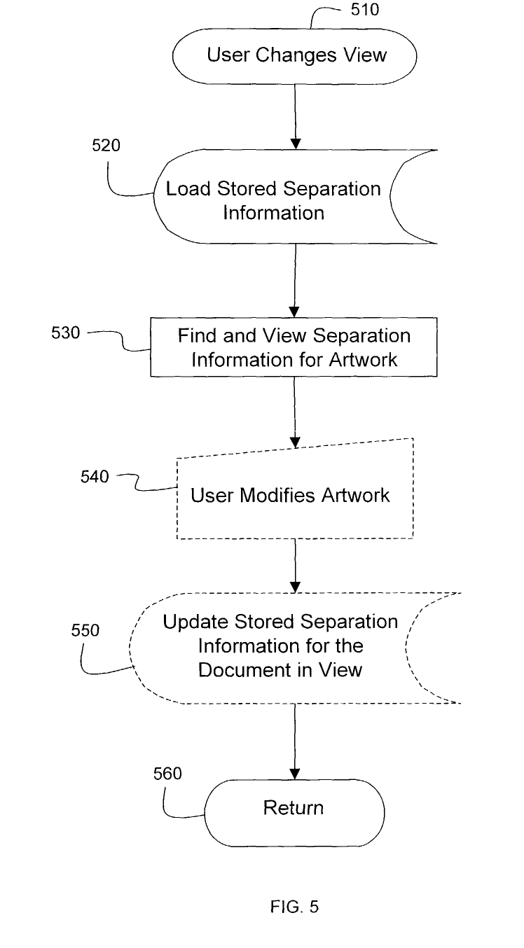

If, in step 250 of FIG. 2 it is determined that the digital artwork being viewed has changed, then the overall method of FIG. 2 continues with the manage view sub-process 270 shown, in an embodiment, in FIG. 5. Referring to FIG. 5, when a user changes view 510 to a different piece of digital artwork (for example, switches to a different Adobe Illustrator™ document window), stored color separation information for that piece of digital artwork is loaded in step 520. In step 530, the color separation is found and viewed by a user (such as a graphic artist or prepress operator). Optionally, in steps 540 and 550, the user may modify and then store the modified color separation information before returning, in step 560, to the overall method shown, in an embodiment, in FIG. 2.

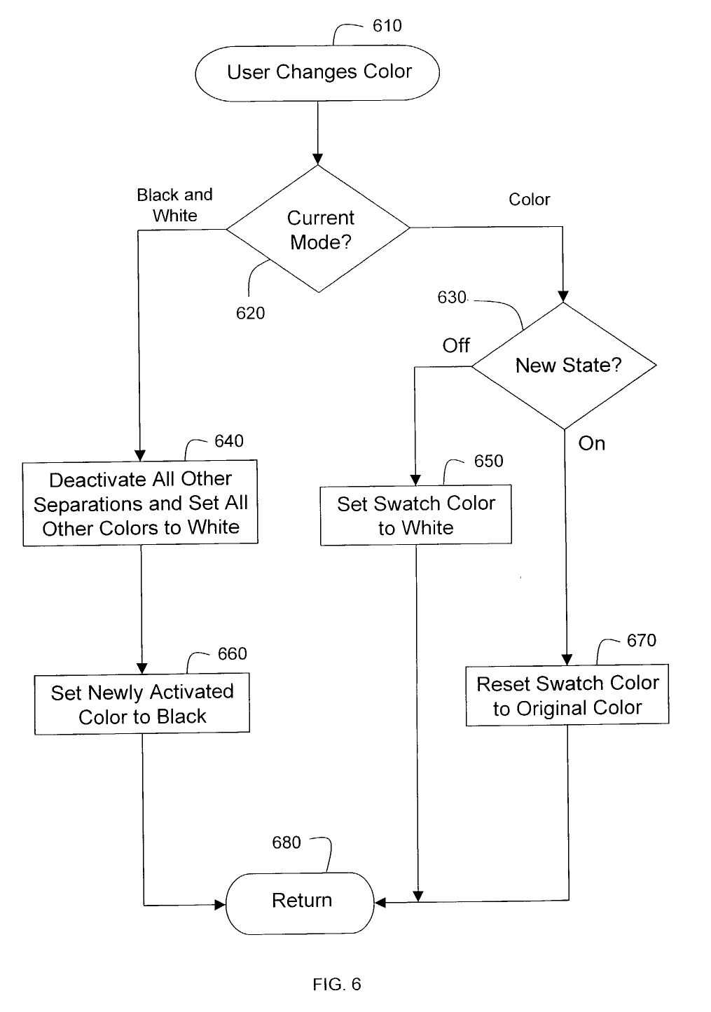

If a color setting is changed in step 240, then (after the color change has been identified in step 250), the present invention proceeds with the manage color change sub-process 280 shown, in an embodiment in FIG. 6. Only some of the steps of the method of FIG. 6 are executed, in accordance with the currently selected color viewing mode of the digital prepress viewing tool 100. As shown in FIG. 6, if it is determined in step 620 that the current mode is black and white, then all color separations are deactivated in step 640 (for example, set to white), and the active color separation is set to black in step 660. If the currently selected color viewing mode is color, then in step 630, it is determined whether the new state of a color clicked in the digital prepress viewing tool 100 is activated (“On”) or deactivated (“Off”). If the new state of the color is on, then the color is reset in step 670 to its original color. If the new state of the color is off, then in step 650, the color is set to white. In step 680, the method of FIG. 6 returns to the overall method shown, in an embodiment, in FIG. 2.

Returning to FIG. 2, in step 290 all listeners (for example, other palette-style tools being used in a native artwork production environment) are notified that a change has been made. As shown in FIG. 2, in an embodiment of the present invention the waiting phase of the method of FIG. 2 repeats from step 230 for as long as the digital prepress color viewing tool is active within the artwork production environment, allowing for the sub-processes 260, 270, and 280 to be repeated as many times as necessary for color separations to be previewed before submission for print processing. As described above, a significant advantage is achieved by allowing color separations to be viewed within a native artwork production environment.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of viewing color separations for digital artwork in a native artwork production environment, the method comprising the steps of:
checking a list of colors for valid colors within the native artwork production environment;
displaying at least one valid color in the list of colors as a color separation within the native artwork production environment; and
managing a user action within the native artwork production environment, the user action being selected from the group consisting of a change of a mode, a change of a view, and a change of a color state.

2. The method of claim 1, wherein, in the step of checking a list of colors for valid colors, the list of colors is checked for a pure process color.

3. The method of claim 1, wherein, in the step of checking a list of colors for valid colors, the list of colors is checked for a spot color.

4. The method of claim 1, further comprising the step of:
converting an invalid color to a valid color using a color mixing tool.

5. The method of claim 1, wherein the change of a mode includes a change of mode from a black and white mode to a color mode.

6. The method of claim 1, wherein the change of a mode includes a change of mode from a color mode to a black and white mode.

7. The method of claim 1, wherein the change of a view includes a change to a view of a different piece of digital artwork.

8. The method of claim 1, wherein the change of a color state includes a change of a color state from activated to deactivated.

9. The method of claim 1, wherein the change of a color state includes a change of a color state from deactivated to activated.

10. The method of claim 1, further comprising the step of:
storing color separation information for a view.

11. The method of claim 1, wherein the method is implemented as a plug-in tool for a native artwork production environment.

12. A system for viewing color separations for digital artwork in a native artwork production environment, the system comprising:
means for checking a list of colors for valid colors within the native artwork production environment;
means for displaying at least one valid color in the list of colors as a color separation within the native artwork production environment; and
means for managing a user action within the native artwork production environment, the user action being selected from the group consisting of a change of a mode, a change of a view, and a change of a color state.

13. The system of claim 12, wherein the means for checking a list of colors for valid colors checks for a pure process color.

14. The system of claim 12, wherein the means for checking a list of colors for valid colors checks for a spot color.

15. The system of claim 12, further comprising:
means for converting an invalid color to a valid color using a color mixing tool.

16. The system of claim 12, wherein the change of a mode includes a change of mode from a black and white mode to a color mode.

17. The system of claim 12, wherein the change of a mode includes a change of mode from a color mode to a black and white mode.

18. The system of claim 12, wherein the change of a view includes a change to a view of a different piece of digital artwork.

19. The system of claim 12, wherein the change of a color state includes a change of a color state from activated to deactivated.

20. The system of claim 12, wherein the change of a color state includes a change of a color state from deactivated to activated.

21. The system of claim 12, further comprising:
means for storing color separation information for a view.

22. The system of claim 12, wherein the system is implemented as a plug-in tool for a native artwork production environment.

23. A digital artwork color viewing system for viewing color separations in a native artwork production environment, the system comprising:
a list of colors including a plurality of colors used in a piece of digital artwork;
at least one tool for activating and deactivating at least one color included in the plurality of colors in order to produce a color separation for the at least one color; and
wherein the at least one tool has a black and white mode and a color mode, and allows for color separation information to be stored for different pieces of digital artwork within the native artwork production environment.

24. The system of claim 23, further comprising:
at least one tool for activating all of the plurality of colors with one action.

25. The system of claim 23, further comprising:
at least one tool for deactivating all of the plurality of colors with one action.

26. The system of claim 23, wherein the black and white mode includes a means for viewing a black and white separation as a negative.
